(19) United States
(12) Patent Application Publication
(10) Pub. No.: US 2014/0176709 A1
(43) Pub. Date: Jun. 26, 2014

(54) Video Overlays for RC/Autonomous Machine

(71) Applicant: CATERPILLAR, INC., Peoria, IL (US)

(72) Inventors: Seth Redenbo, Metamora, IL (US); Brian Funke, Peoria, IL (US); Daniel Dunn, Dunlap, IL (US)

(73) Assignee: Caterpillar, Inc., Peoria, IL (US)

(21) Appl. No.: 13/725,271

(22) Filed: Dec. 21, 2012

(51) Int. Cl. H04N 7/18

(52) U.S. Cl. CPC H04N 7/18
USPC 348/143

(57) ABSTRACT

A method and system for remote monitoring of an earthmoving machine provide machine video with overlaid graphical indicators via a video display at an operator center. In an embodiment, video data and machine data encompassing machine operational parameters are captured at the machine. The video data and the machine data are transmitted to the operator center and graphical indicators are generated at the operator center, with each graphical indicator corresponding to a separate machine operational parameter. The machine video data is then displayed on a display screen at the operator center with the graphical indicators overlaid on the displayed video in multiple separate region of the display screen.

### TECHNICAL FIELD OF THE DISCLOSURE

The present disclosure relates to remote and autonomous control of earth-moving machines and, more particularly, relates to a system and method for displaying machine information to a remote operator via the overlay of separate graphical indicators on a video display.

### BACKGROUND OF THE DISCLOSURE

Many industrial activities require the use of earth moving machines, material lifting and handling machines and other large machines. In order to improve operator safety and productivity while reducing operator fatigue, the operation of such machines is increasingly automated and/or executed via remote control (RC). In this way, an operator may monitor and control a machine from the safety and quiet of an operator center rather than spending the work day in the cockpit of the machine itself.

However, the operational connection between the operator and the machine is often attenuated by the remote connection between the operator and the machine, i.e., by the absence of the operator from the machine cockpit. For example, a remote operator is not able to physically feel a machine's acceleration or deceleration, or changes in a machine's tilt or inclination. As such, a number of systems have been proposed to provide greater situational awareness to the operator of an RC or autonomous machine.

For example, U.S. Patent Application No. 20120154572 to Stratton et al. discloses a simulation and control system for a machine, including a user interface configured to display a simulated environment for a remotely located machine via a controller. The controller receives real-time information from the machine related to the operation of the machine at a worksite. The controller simulates the worksite, the operation of the machine, and the movement of a machine tool based on the received information. The controller then provides to the user interface the simulated worksite, operation, and movement in the simulated environment to allow operator control. In addition to the visual cues provided by the simulated machine and worksite, the display also includes a simulated information panel. The panel is displayed across the lower portion of the display screen and may include simulated dials and other indicators.

Nonetheless, there is still a need for enhancing operator situational awareness through the use of real-time video information supplemented in a manner that does not lead to excess attention capture or excess obscuring of the display. The present disclosure is directed at least in part to a system that may address this need. However, it should be appreciated that the solution of any particular problem is not a limitation on the scope of this disclosure nor of the attached claims except to the extent expressly noted. Additionally, the inclusion of material in this Background section is not an indication that the material represents known prior art except as otherwise expressly noted, e.g., by patent or publication citation.

### SUMMARY OF THE DISCLOSURE

In accordance with one aspect of the present disclosure, a method is provided for displaying information regarding an earthmoving machine via a video display at a remote operator center. The method includes receiving machine video data and machine operational data at the remote operator center and generating graphical indicators corresponding to machine operational parameters. A guide graphic is generated based on a calibration procedure. With the machine video data being displayed on a display screen at the operator center, the graphical indicators and the guide graphic are overlaid on the video data. Each graphical indicator is displayed in a separate region of the display screen.

In accordance with another aspect of the present disclosure, a further method is provided for remote monitoring of an earthmoving machine via a video display at an operator center. The method includes capturing video data at the machine and capturing machine data at the machine regarding machine operational parameters. The video data and the machine data are transmitted to the operator center and graphical indicators are generated at the operator center, with each graphical indicator corresponding to a separate machine operational parameter. The machine video data is displayed on a display screen at the operator center and the graphical indicators are overlaid on the displayed video such that each graphical indicator is displayed in a separate region of the display screen.

In accordance with yet another aspect of the present disclosure, a system is provided for remotely monitoring an earthmoving machine. The system includes a video display screen, a source for supplying machine operational data, and a source for supplying video data gathered by a video camera at the machine. An included controller is configured to receive the machine operational data and video data and to overlay the machine operational data on the machine video data. With respect to the overlay, two or more machine operational parameters associated with the machine operational data are displayed as separate graphical indicators overlaid on the machine video data.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram of a machine data and control system in accordance with an aspect of the disclosure;

FIG. 2 is a schematic diagram of an operator center architecture in accordance with an aspect of the disclosure;

FIG. 3 is a simplified illustration of an example display showing video material and graphical overlays in accordance with an aspect of the disclosure with a machine blade in a first position;

FIG. 4 is a simplified illustration of an example display showing video material and graphical overlays in accordance with an aspect of the disclosure with the machine blade in a second position;

FIG. 5 is a simplified illustration of an example display showing video material and graphical overlays in accordance with an aspect of the disclosure wherein a tilt in machine orientation is displayed via a rotation of the graphical overlays; and

FIG. 6 is a flow chart illustrating a process of machine data presentation and control in accordance with an aspect of the disclosure.

### DETAILED DESCRIPTION OF THE DISCLOSURE

The present disclosure provides a system and method for remote monitoring of an earthmoving machine using machine video with overlaid graphical indicators. In an embodiment, video data and machine data encompassing machine operational parameters are captured at the machine. The video data and the machine data are transmitted to the operator center, and graphical indicators are then generated at the operator center, with each graphical indicator corresponding to a separate machine operational parameter. The machine video data is then displayed on a display screen at the operator center with the graphical indicators overlaid on the displayed video in multiple separate region of the display screen.

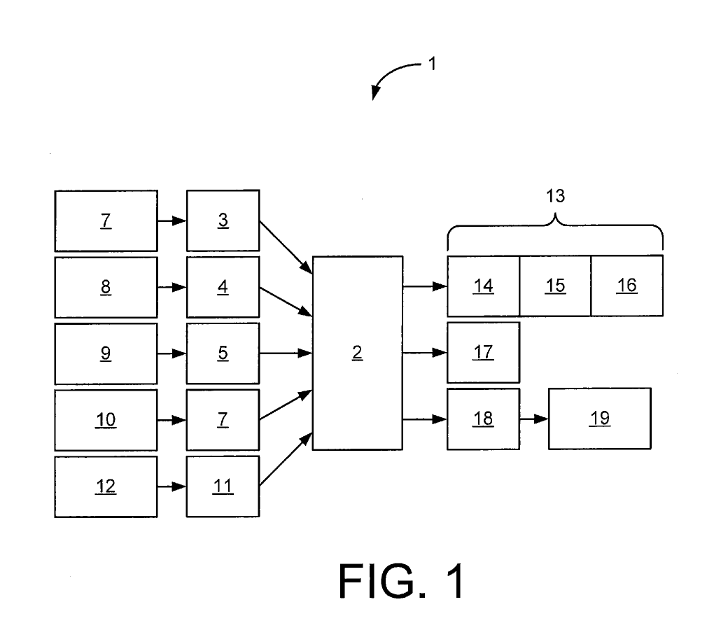

Having given the above overview, and referring now more specifically to the drawing figures, FIG. 1 is a schematic diagram of a machine data and control system in accordance with an implementation of the disclosed principles. The illustrated machine data and control system 1 includes a controller 2 in communication with multiple inputs and outputs to be described. The controller 2 may be any device that controls the receipt and processing of data obtained from the various inputs while also generating commands and/or data for provision to the various outputs.

The controller 2 may be based on integrated circuitry, discrete components, or a combination of the two. In an embodiment, the controller 2 is implemented via a computerized device such as a PC, laptop computer, integrated machine computer which may be configured to serve the functions of controller 2 as well as numerous other machine functions. In an alternative embodiment, the controller 2 is a dedicated module. In such a case, the controller 2 may be a processor-based device or collection of devices.

Regardless of how it is implemented, the controller 2 operates, in an embodiment, by executing computer-executable instructions read from a nontransitory computer-readable medium such as a read only memory, a random access memory, a flash memory, a magnetic disc drive, an optical disc drive, and the like. The data processed by the controller 2 may be read from memory in addition to being obtained from one or more of the various machine inputs. The memory may reside on the same integrated circuit device as the processor of the controller 2 or may be alternatively or additionally located separately from the controller 2.

While the controller 2 and its various inputs and outputs will be described by way of a spoke and hub architecture, it will be appreciated that any suitable bus type may be used. For example, inputs and outputs may be serially multiplexed by time or frequency rather than being provided over separate connections. It will be appreciated that peripheral circuitry such as buffers, latches, switches and so on may be implemented within the controller 2 or separately as desired. Because those of skill in the art will appreciate the usage of such devices, they will not be further described herein.

As noted above, the controller 2 receives a number of inputs or input signals. In the illustrated embodiment, the controller 2 is shown receiving a GPS input 3, a pitch input 4, a roll input 5, and a camera data input 6. The GPS input 3 may provide location data containing an indication of a current location of the machine. Such data may be derived from a GPS module 7. It will be appreciated that the GPS module 7 may be integrated with the control or data systems of the machine or may be a separate unit.

The pitch input 4 provides data containing an indication of the current pitch angle of the machine. Pitch angle typically references the angle between a level surface and the machine axis in the direction of travel. By way of example, the data containing the indication of the current pitch angle may be derived from a pitch sensor module 8. The pitch sensor module, which may be integrated with the machine data or control systems or may be a separate module, may measure the pitch of the tracks or other undercarriage of the machine or may measure the pitch of the machine cab. Pitch may be measured via a gravitational sensor or other internal or external means for detecting an amount of divergence from a level attitude.

Similar to the pitch input 4, the roll input 5 provides data indicative of a degree of roll of the machine (roll angle). The roll angle typically measures the angle between a level surface and the machine axis perpendicular to the direction of travel, and may be obtained from or derived by a roll sensor module 9. The roll sensor module 9, which may be an integrated or separate component in the same manner as the pitch sensor module 8, may measure the roll angle of the undercarriage or of the cab depending upon the implementation desired. Measurement of the roll angle may be made via a gravitational sensor or other internal or external means as noted above with respect to the measurement of the pitch angle.

As noted above, the inputs to the controller 2 may also include a camera data input 6. The camera data input receives data from one or more onboard cameras 10. The one or more cameras 10 are digital video cameras in an embodiment, and may be situated to show portions of the machine and/or surrounding terrain. For example, a camera may be directed forward to capture video of the terrain toward which the machine is travelling as well as the position of a forward-placed implement or tool, such as a blade. The one or more cameras 10 may also include a rearward-facing camera to capture video of the terrain, objects, and/or personnel that the machine may travel towards if operated in reverse.

Finally, the controller 2 also receives a radio input 11 in an embodiment. The radio input 11 provides the controller 2 with control signals received by an onboard radio receiver 12. The control signals may be received from a remote transmitter operated autonomously or by a human operator, and may provide control instructions to one or more machine systems or functions such as acceleration, deceleration, steering, tool placement and angle, and so on. The onboard radio receiver 12 may be integrated with the machine data and control systems or may be a separate module.

As noted above, the controller 2 also provides a number of outputs in an embodiment. For example, the controller 2 may provide a radio command output 13 to convey control commands to various machine systems or functions. In an embodiment, the control commands conveyed by the radio command output 13 include an acceleration/deceleration command output 14, a steering command output 15, and a tool position/attitude command output 16.

The acceleration/deceleration command output 14 may be configured and routed to control the machine transmission, brakes, and engine, electric propulsion motor(s) and/or hydraulic propulsion motor(s). The steering command output 15 may be configured and routed to control the direction of travel of the machine. The mechanism for directional control will be related to the machine type, but example steering mechanisms include wheel steering, frame articulation, differential track movement, and so on. The tool position/attitude command output 16 provides tool control commands to manipulate a tool or implement mounted on the machine. In the case of a machine having a blade, e.g., a dozer, the tool control commands may include commands to set the blade height, blade tilt and blade roll for example.

The controller 2 also provides a camera control command output 17 in an embodiment. The command control output 17 includes camera command signals to set the position or function of one or more cameras mounted on the machine. As noted above, such cameras may include a forward directed video camera and/or a rearward directed video camera.

Finally, the controller also provides a radio link output 18. The radio link output conveys machine operation data and camera data to a transmitter module 19. The transmitter module 19 is configured in an embodiment to wirelessly convey the received data to a remote receiver, e.g., at a remote operator station.

The machine operation inputs 6 to the controller 2 include various data and control inputs for use by the controller 2 for purposes of feedback control or to provide information to the remote operator. These machine operation inputs may include, for example, an acceleration input 10, a tool position input 11, and a steering input 12. The acceleration input 10

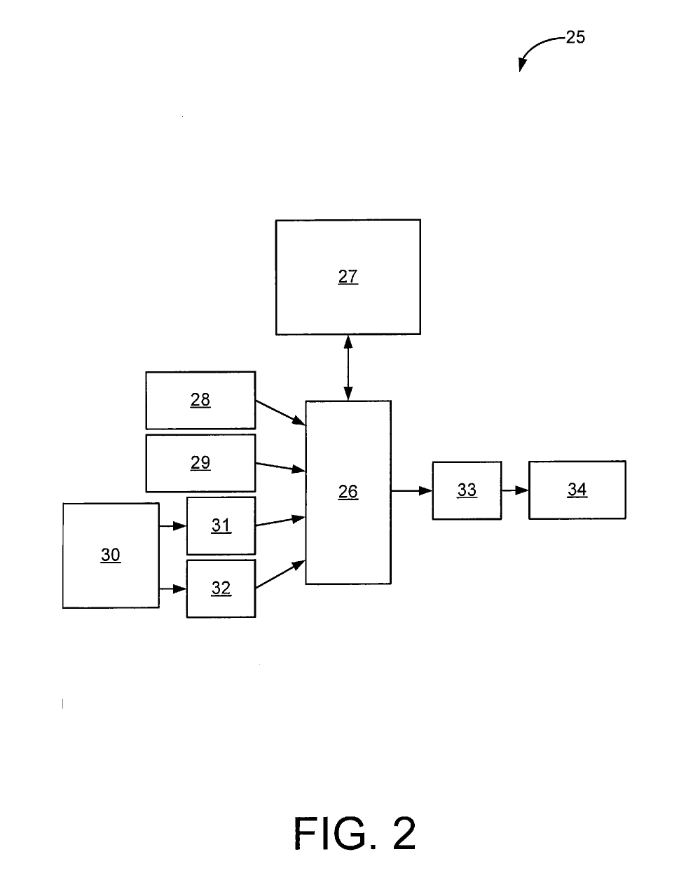

As noted above, the controller 2 is in communication, via certain input and outputs, with a remote operator center in an embodiment. The schematic diagram of FIG. 2 illustrates an operator center system implementation that may be used in conjunction with the system illustrated in FIG. 1. The operator center architecture 25 includes a computing device 26, which may be a personal computer, laptop computer, computing console, or other computing device.

The computing device 26 is configured to receive a number of inputs and to provide a number of outputs. In an embodiment, the computing device 26 is linked to display screen 27. The display screen 27 may be separate from or integrated with the computing device 26. While the display screen 27 is configured to display material to a user or operator of the computing device 26, the display screen may also act as an input device, receiving user input via a touch screen mechanism for example.

In addition to the display screen 27, operator inputs may also be received via a keyboard input device 28 connected to the computing device 26. As with the display screen 27, the keyboard input device 28 may be an external device or may be integrated with the computing device 26. Further user input to the computing device 26 may be provided via one or more peripheral user interface devices such as a joystick 29 or other input device.

The computing device 26 is further configured and connected to receive signals from a radio receiver 30. In particular, in an embodiment, the computing device 26 receives a video data input 31, corresponding to remotely transmitted video information, and a machine data input 32, corresponding to remotely transmitted machine data, from the radio receiver 30. The remotely transmitted video information and machine data may originate from a machine data and control system 1 as described above with respect to FIG. 1.

To facilitate communications back to the machine data and control system 1, the computing device 26 is further configured and connected to provide a remote control output 33 to an operator station transmitter 34. The operator station transmitter 34 is configured to communicate with the onboard radio receiver 12 of the remote machine data and control system 1. In particular, the range and frequency of transmission are such as to be received and decoded by the onboard radio receiver 12.

During remote RC and/or autonomous operation of one or more machines equipped as discussed above with respect to FIG. 1, the display screen 27 is driven by the controller so as to show the live video data received from one or more cameras located on one or more remote machines as well as a graphical overlay reflecting various machine operating parameters, status, and/or environment. In an embodiment, the graphical overlay comprises a plurality of graphical indicators located in a plurality of distinct regions of the display. Each graphical indicator comprises an image, rather than a purely textual presentation, that conveys information regarding machine operating parameters, machine status, and/or machine environment.

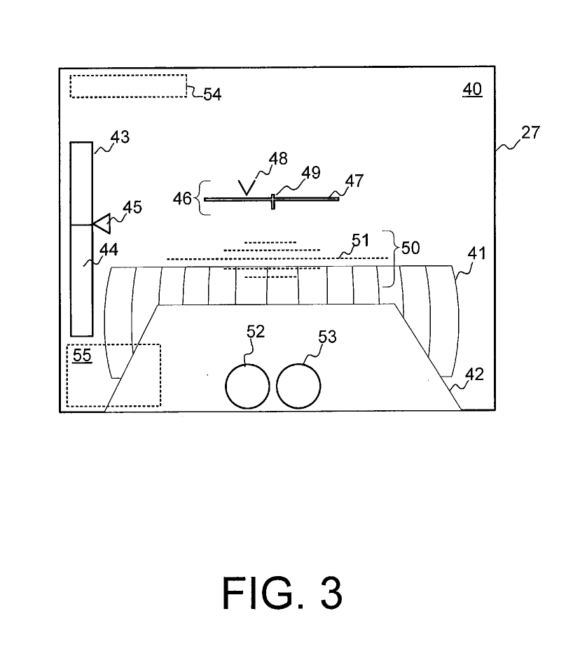

An example display in accordance with this embodiment is shown schematically in FIG. 3. In the illustrated example, the display screen 27 presents a video display 40 including video material corresponding to video data captured by a forward-facing camera mounted on a remote machine. The video material includes, in the illustrated embodiment, video of a portion of the earthmoving machine itself as well as the surrounding terrain, structures, objects and/or personnel. To simplify the drawing figure, only the machine front portion 42 and machine blade 41 are shown.

Overlaid on the displayed video material in the video display 40 are a number of graphical information objects. For example, a slot graphic 43 shows the extent to which the machine, a dozer in this example, has progressed within the current slot. The slot graphic 43 in the illustrated embodiment includes a slot progress bar 44 that reflects the location of the machine in the current slot. As will be described later in more detail, the slots are predefined by an operator or other personnel, with respect to location, orientation, and length. The machine's current location, identified by GPS for example, is then mapped to the defined bounds of the slot. In the illustrated embodiment, the slot progress bar 44 also includes a slot indicator 45 that identifies the machine's current position along the slot.

In a separate region of the video display 40, a slot position indicator 46 is included to illustrate the lateral position of the machine within the slot. The slot position indicator 46 includes a centering indicator 47 as well as a machine location indicator 48. The centering indicator 47 indicates the center of the slot via a graphical indication. In the illustrated embodiment, the centering indicator 47 includes a level line bisected by a transverse tick 49 indicating the center of the slot. The machine location indicator 48 in the illustrated embodiment comprises a pointer or carrot identifying the position of the machine in the slot relative to the slot center as reflected by the transverse tick 49 on the level line.

A blade height reference graphic 50 (also referred to herein as a guide graphic) is included in the video display 40 beneath the slot position indicator 46 in the illustrated embodiment. The illustrated blade height reference graphic 50 includes a plurality of parallel height reference lines such as height reference line 51. Height reference line 51, which is the longest of the height reference lines, represents the visual placement of the top of the blade 41 when the blade's bottom edge, not shown, is level with the bottom of the machine tracks or other ground engaging mechanism, i.e., level with the lowest point on the machine. Similarly, the reference lines above height reference line 51 provide references for blade placement while the machine is spreading material, whereas the reference lines below height reference line 51 provide references for blade placement while the machine is digging.

In an embodiment, machine pitch and roll indicators may be provided within another separate region of the video display 40. In the illustrated example, the pitch and roll indicators are centered in the video display 40 at the bottom of the screen 27 beneath the blade height reference graphic 50. The machine pitch indicator graphic 52 may be a dial indicator, horizon indicator or other graphical indicator of machine pitch. In an alternative embodiment, the machine pitch indicator graphic 52 includes alternatively or additionally a textual indication of machine pitch, e.g., in degrees.

Similarly, a machine roll indicator graphic 53 provides an indication of the machine roll. As with the machine pitch indicator graphic 52, the machine roll indicator graphic 53 may be a dial indicator, horizon indicator or other graphical indicator of machine roll, and in an alternative embodiment, may include alternatively or additionally a textual indication of machine roll.

In addition to the graphical indicators provided to visually apprise the operator of the machine status and condition, one or more text field may also be included in separate regions of the video display 40. By way of example, an opaque machine name field 54 is provided in the upper left hand corner of the video display 40. Similarly, a transparent machine data field 55 may be provided, as shown in the lower left hand corner of the video display 40. This field may textually convey track elevation, fuel remaining, number of cuts left, and other information as needed by the operator.

In the illustration of FIG. 3, it can be seen that the machine is currently in a digging configuration since the top edge of the machine blade 41 lies below the central height reference line 51. Similarly, it can be seen that the machine is not currently centered in the slot, but instead lies somewhat to the left of center, as indicated by the location of the machine location indicator 48 to the left of the transverse tick 49 indicating the center of the slot.

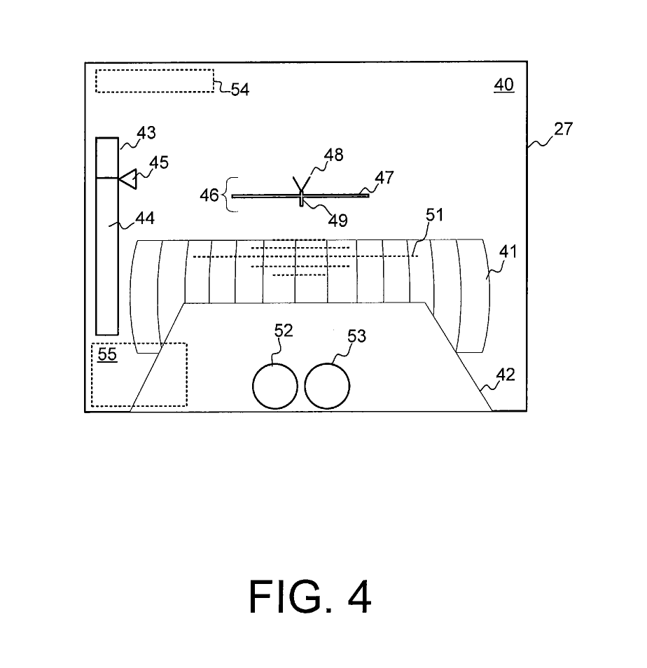

As the machine configuration, direction, orientation and location change, the displayed video will naturally change in real time. In addition, the graphical indicators in the video display 40 are updated based on new data arriving via the local radio receiver 30 from the transmitter module 19 onboard the machine. An example of changes in the graphical indicators corresponding to changes in the machine configuration, location and orientation is shown in FIG. 4.

In the illustrated example, the machine blade 41 has been raised (relative to FIG. 3) such that the top edge of the blade 41 is above the central height reference line 51. In the illustrated example, this informs the operator that the blade is in a spreading position rather than a level position or a digging position. In addition, the machine location indicator 48 is centered in the centering indicator 47 on the transverse tick 49, indicating that the machine is centered in the slot. The slot graphic 43, moreover, indicates to the operator that the machine had traveled further along the slot relative to the progress shown in FIG. 3. In particular, the slot progress bar 44 has grown to represent a larger portion of the slot graphic 43, indicating that a larger portion of the slot has been traveled.

Although certain machine environmental and operational data are conveyed by the graphical indicators displayed in the video display 40 on the display screen 27 in the foregoing examples, there is no requirement that these precise parameters be graphically conveyed or that the given graphics be used only in the described manner. For example, certain graphical indicators may additionally be used to convey another parameter such as machine roll or tilt angle.

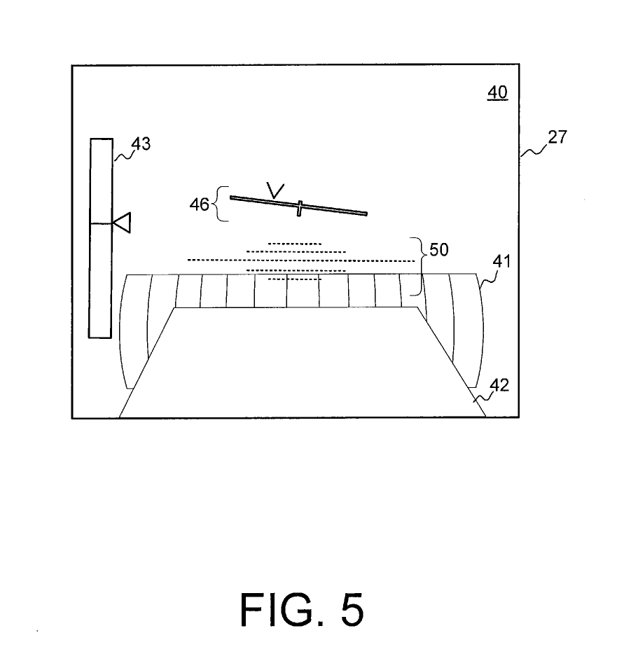

In the example shown in FIG. 5, the machine has acquired a roll to the left by an angle of several degrees. This is shown by the clockwise rotation of the slot position indicator 46. In the illustrated example, the slot graphic 43 and blade height reference graphic 50 have remained fixed in the machine frame of reference. In the illustrated example, the camera is mounted on the machine, and as such, the video information itself will also continue to appear level in the video display 40 despite the roll of the machine.

In an embodiment, the remote operator of the machine may select among multiple machines for remote control or autonomous control. In this embodiment, the video material displayed on the video display 40 originates from one or more cameras on the selected machine. However, additional video from additional machines that are not being remotely controlled but are being monitored may be additionally displayed on the same or different display screen.

### INDUSTRIAL APPLICABILITY

In general terms, the present disclosure sets forth a system and method applicable to earth-moving machines and other industrial machines used in remote control application such as in mining applications wherein it is desired to provide a remote operator with video information as well as graphical machine operational information. As noted above, the system operates by collecting video data as well as machine operation and configuration data at the machine of interest, and then transmitting the collected information to a remote station. At the remote station, the received information is used to present a video feed to the operator and to overlay certain machine information in graphical format onto the video material.

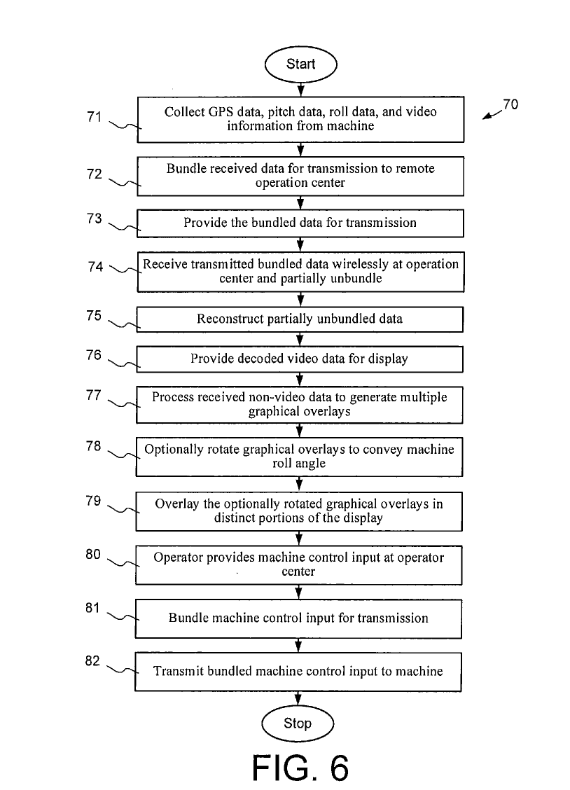

While there are numerous alternative ways in which to implement the described system, an example process flow is illustrated via the flow chart 70 of FIG. 6 with reference to the architectures of FIGS. 1-2 and the display of FIG. 3. The process begins at stage 71, wherein the controller 2 collects GPS data reflective of the machine location, pitch data reflective of the machine pitch angle, roll data reflective of the machine roll angle, and video information from a camera mounted on the machine.

The controller 2 then bundles the received data at stage 72 for transmission to the remote operation center. Such bundling may include one or more forms of preparing the data for transmission including quantizing, compression, packetizing, multiplexing, and so on. At stage 73, the controller 2 provides the bundled data for transmission via the radio link output 18 for provision to the transmitter module 19 and eventual wireless transmission.

At stage 74, the radio receiver 30 receives the transmitted bundled data wirelessly and partially unbundles it. In some implementations, the unbundling of data may be partially accomplished in the process of receiving the data, e.g., by way of demultiplexing, depacketizing, and so on. At stage 75, the partially unbundled data is reconstructed, accounting for any data losses caused in coding or compression.

The reconstruction of the data may vary by data type. For example, discrete data elements such as pitch angle, roll angle, machine location, and so on may arrive unencoded or encoded via a simple algorithm such as a delta algorithm. In contrast, in an implementation, the video data is encoded via a suitable compression algorithm such as H.264 or VP8 in order to reduce bandwidth usage in the radio channel.

At stage 76, the decoded video data is provided for display, i.e., via display screen 27. At least a portion of the received data other than video data is processed at stage 77 to generate multiple graphical overlays in distinct portions of the visual display. Thus, for example, the received location data may be compared with the known bounds of the current slot to generate the slot graphic 43 showing the extent to which the machine has progressed within the current slot. Similarly, the received location data may be used to generate the slot position indicator 46 showing the machine position laterally within the slot.

In contrast, the blade height reference graphic 50 is not generated based on received data in an embodiment. Rather, the vertical location of the blade height reference graphic 50 may be set based on an initial calibration process. In an example of such a calibration process, the operator may place the bottom edge of the blade 41 level with the bottom of the machine's ground engaging elements, e.g., tracks or wheels. By way of example, this may be accomplished by locating the machine on level ground and lowering the blade bottom to the ground. The operator may then set the vertical height of the blade height reference graphic 50 such that the height reference line 51 is level with the top of the blade 41.

Proceeding on with the process 70, in an embodiment, any rotation of the group of generated graphical overlays is then executed, e.g., based on received roll data, at stage 78. The generated and optionally rotated graphical overlays are then overlaid on the video display in distinct portions of the display at stage 79, e.g., as shown in FIG. 5.

The format of the video information during transmission and during display is not critical, but an example format is the ITU H.264 format. Similarly, the format of the generated graphical overlays is not critical, but example formats include a bitmap format and a vector graphic format.

The superposition of the generated graphical overlays on the displayed video may be executed in a number of ways. For example, the video memory may be overwritten in the appropriate regions by the graphical overlays. As another example, the content of the video memory in the appropriate regions may be mixed with the graphical overlays for each region by alpha blending or other suitable technique. In addition to these examples, it will be appreciated that there exist various other techniques that may be used to superimpose the generated graphical overlays on the displayed video.

At stage 80, the operator provides a machine control input at the operator center, e.g., via a joystick, touch screen, keypad, and/or other input device. The machine control input may be one or more of an acceleration or deceleration input, a machine direction input, a machine brake input, a machine steering input, a tool positioning input, or other machine control input. The machine control input is bundled for transmission at stage 81 and is transmitted to the machine at stage 82 for implementation of the commanded control action.

It will be appreciated that the present disclosure provides a system and method for facilitating remote operator visualization of the operation of a machine and the machine environment. While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for displaying information regarding an earthmoving machine via a video display at a remote operator center, the method comprising:
receiving machine video data and machine operational data at the remote operator center, the machine operational data including data relating to a plurality of machine operational parameters;
generating a plurality of graphical indicators, each graphical indicator corresponding to a different one of the plurality of machine operational parameters;
generating a guide graphic based on a calibration procedure;
displaying the received machine video data on a display screen at the operator center; and
visually overlaying the plurality of graphical indicators and the guide graphic on the displayed machine video data, each graphical indicator being displayed in a separate region of the display screen.

2. The method for displaying information regarding an earthmoving machine in accordance with claim 1, wherein the plurality of machine operational parameters include a machine location relative to a length of a current slot.

3. The method for displaying information regarding an earthmoving machine in accordance with claim 2, wherein the plurality of machine operational parameters further include the machine location relative to a width of the current slot.

4. The method for displaying information regarding an earthmoving machine in accordance with claim 1, wherein the machine is a dozer having a blade and wherein the guide graphic is a blade height reference graphic indicating a position of the blade relative to a lowest point on the machine.

5. The method for displaying information regarding an earthmoving machine in accordance with claim 4, wherein the blade height reference graphic comprises a plurality of parallel lines.

6. The method for displaying information regarding an earthmoving machine in accordance with claim 1, wherein the plurality of graphical indicators comprise bitmap graphics.

7. The method for displaying information regarding an earthmoving machine in accordance with claim 1, wherein the plurality of graphical indicators comprise vector graphics.

8. The method for displaying information regarding an earthmoving machine in accordance with claim 1, wherein the machine video data comprises H.264 video data.

9. The method for displaying information regarding an earthmoving machine in accordance with claim 1, wherein the plurality of machine operational parameters include a machine roll angle and wherein visually overlaying the plurality of graphical indicators and the guide graphic on the displayed machine video data comprises rotating the plurality of graphical indicators and the guide graphic to represent the machine roll angle.

10. A method for remote monitoring of an earthmoving machine via a video display at an operator center, the method comprising:
capturing video data at the machine via a video camera;
capturing machine data at the machine relating to a plurality of machine operational parameters;
transmitting the video data and the machine data to the operator center;
generating a plurality of graphical indicators at the operator center, each graphical indicator corresponding to a different one of the plurality of machine operational parameters;
displaying the machine video data on a display screen at the operator center with the plurality of graphical indicators overlaid on the displayed machine video data such that each graphical indicator is displayed in a separate region of the display screen.

11. The method for remote monitoring of an earthmoving machine via a video display at an operator center as in claim 10, wherein the plurality of machine operational parameters include a machine location relative to a length of a current slot and a machine location relative to a width of the current slot.

12. The method for remote monitoring of an earthmoving machine via a video display at an operator center as in claim 10, wherein the machine is a dozer having a blade and wherein displaying the machine video data on a display screen at the operator center with the plurality of graphical indicators overlaid on the displayed machine video data further comprises displaying a guide graphic overlaid on the displayed machine video data wherein the guide graphic is a blade height reference graphic indicating a position of the blade relative to a lowest point on the machine.

13. The method for remote monitoring of an earthmoving machine via a video display at an operator center as in claim 12, further comprising calibrating the blade height reference graphic.

14. The method for remote monitoring of an earthmoving machine via a video display at an operator center as in claim 12, wherein the blade height reference graphic comprises a plurality of parallel lines.

15. The method for remote monitoring of an earthmoving machine via a video display at an operator center as in claim 10, wherein the plurality of graphical indicators comprise one of bitmap graphics and vector graphics.

16. The method for remote monitoring of an earthmoving machine via a video display at an operator center as in claim 10, wherein the machine video data comprises H.264 video data.

17. The method for remote monitoring of an earthmoving machine via a video display at an operator center as in claim 12, wherein the plurality of machine operational parameters include a machine roll angle and wherein displaying the machine video data on a display screen at the operator center with the plurality of graphical indicators overlaid on the displayed machine video data further comprises rotating the plurality of graphical indicators and the guide graphic to represent the machine roll angle.

18. A system for remotely monitoring an earthmoving machine, the system comprising:
a video display screen;
a machine operational data source for supplying machine operational data, the machine operational data comprising a plurality of machine operational parameters;
a machine video data source for supplying video data gathered by a video camera at the machine; and
a controller configured to receive the machine operational data and the machine video data and to overlay the machine operational data on the machine video data such that two or more of the plurality of machine operational parameters are displayed as separate graphical indicators overlaid on the machine video data.

19. The system for remotely monitoring an earthmoving machine in accordance with claim 18, wherein the earthmoving machine is a dozer.

20. The system for remotely monitoring an earthmoving machine in accordance with claim 18, wherein the controller is further configured to receive operator input from a human operator and to transmit the operator input to the machine to provide machine control.
